(19) United States
(12) Patent Application Publication
(10) Pub. No.: US 2025/0175551 A1
(43) Pub. Date: May 29, 2025

(54) METHOD FOR PERFORMING OPERATION RELATED TO NOTIFICATION, AND ELECTRONIC DEVICE SUPPORTING SAME

(71) Applicant: Samsung Electronics Co., Ltd., Suwon-si (KR)

(72) Inventors: Daehyung JO, Suwon-si (KR); Jisoo KANG, Suwon-si (KR); Jinmin KIM, Suwon-si (KR); Jinsung KIM, Suwon-si (KR); Jaejin AHN, Suwon-si (KR)

(21) Appl. No.: 19/035,280

(22) Filed: Jan. 23, 2025

Related U.S. Application Data
(63) Continuation of application No. PCT/KR2023/009530, filed on Jul. 5, 2023.

(30) Foreign Application Priority Data
Jul. 25, 2022 (KR) 10-2022-0091743
Aug. 25, 2022 (KR) 10-2022-0107194

(51) Int. Cl. H04M 1/72409; G06F 3/04842; H04M 1/72484

(52) U.S. Cl. CPC H04M 1/724095; G06F 3/04842; H04M 1/72484

(57) ABSTRACT

An electronic device is provided. The electronic device includes a communication module, a display, memory storing one or more computer programs, and one or more processors communicatively coupled to the communication module, the display, and the memory, wherein the one or more computer programs include computer-executable instructions that, when executed by the one or more processors individually or collectively, cause the electronic device obtain, from an external electronic device, through the communication module, information related to a first notification for a first application, display, through the display, at least one object corresponding to at least one operation related to the first notification, select an object of the displayed at least one object, based on information including the first notification, determine, among the electronic device and the external electronic device, a device that is to perform the operation corresponding to the selected object, and control the determined device to perform an operation corresponding to the selected object.

### CROSS-REFERENCE TO RELATED APPLICATION(S)

This application is a continuation application, claiming priority under § 365(c), of an International application No. PCT/KR2023/009530, filed on Jul. 5, 2023, which is based on and claims the benefit of a Korean patent application number 10-2022-0091743, filed on Jul. 25, 2022, in the Korean Intellectual Property Office, and of a Korean patent application number 10-2022-0107194, filed on Aug. 25, 2022, in the Korean Intellectual Property Office, the disclosure of each of which is incorporated by reference herein in its entirety.

### BACKGROUND

### 1. Field

The disclosure relates to a method for performing an operation related to a notification, and an electronic device supporting the same.

### 2. Description of Related Art

As technology evolves, various services and additional functions are provided by linking multiple electronic devices. In particular, as a wearable device worn on a part of a user's body is linked with a smartphone, events occurring in applications installed on the smartphone may be identified through the wearable device without directly looking at the smartphone. For example, when a messaging application on a smartphone receives a new message, the user may identify whether the new message has been received and its contents through a wearable device without the user having to look directly at the smartphone.

When a wearable device attempts to perform an operation of calling a message sender about the received message, the wearable device may not be able to run the phone application due to limitations in the application programming interface (API) distributed on an application platform. A wearable device may request a smartphone to run a phone application.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for performing operation related to notification, and electronic device supporting same.

Additional aspects will be set forth in part in the description which follows and, in part, will be apparent from the description, or may be learned by practice of the presented embodiments.

In accordance with an aspect of the disclosure, an electronic device is provided. The electronic device includes a communication module, a display, memory storing one or more computer programs, and one or more processors communicatively coupled to the communication module, the display, and the memory, wherein the one or more computer programs include computer-executable instructions that, when executed by the one or more processors individually or collectively, cause the electronic device to obtain information related to a first notification for a first application from an external electronic device through the communication module, display at least one object corresponding to at least one operation related to the first notification through the display, select one object from the displayed at least one object, determine, among the electronic device and the external electronic device, a device that is to perform an operation corresponding to the selected object, based on information including the first notification, and control the determined device to perform an operation corresponding to the selected object.

In accordance with another aspect of the disclosure, a method for operating an electronic device is provided. The method includes obtaining, from an external electronic device through a communication module, information related to a first notification for a first application, displaying, through a display, at least one object corresponding to at least one operation related to the first notification, selecting an object of the displayed at least one object, based on information including the first notification, determining, among the electronic device and the external electronic device, a device that is to perform an operation corresponding to the selected object, and controlling the determined device to perform an operation corresponding to the selected object.

In accordance with another aspect of the disclosure, one or more non-transitory storage media storing one or more computer programs including computer-executable instructions that, when executed by one or processors of an electronic device, cause the one electronic device to operations are provided. The operations include obtaining, from an external electronic device, through a communication module, information related to a first notification for a first application, displaying, through a display, at least one object corresponding to at least one operation related to the first notification, selecting an object of the displayed at least one object, based on information including the first notification, determining, among the electronic device and the external electronic device, a device that is to perform an operation corresponding to the selected object, and controlling the determined device to perform an operation corresponding to the selected object.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIG. 3 is a flowchart illustrating a method for performing an operation related to a notification according to an embodiment of the disclosure;

FIG. 4 is a flowchart illustrating a method in which an electronic device performs an operation related to a notification obtained from an external electronic device according to an embodiment of the disclosure;

FIG. 5 is a flowchart illustrating an operation of controlling an electronic device to perform an operation corresponding to a selected object according to an embodiment of the disclosure;

FIG. 6 is a flowchart illustrating an operation in which an electronic device requests an external electronic device to perform an operation corresponding to a selected object, according to an embodiment of the disclosure;

FIG. 7 is a flowchart illustrating an operation of determining a device to perform an operation related to a notification, based on a user input according to an embodiment of the disclosure;

FIG. 8 is a flowchart illustrating an operation of determining a device to perform an operation related to a notification, based on a state and an operation pattern of an electronic device according to an embodiment of the disclosure;

FIG. 9 illustrates a notification shared between an electronic device and an external electronic device and an operation related to a notification according to an embodiment of the disclosure;

FIG. 10 illustrates an operation in which an electronic device requests an external electronic device to perform an operation corresponding to a selected object, according to an embodiment of the disclosure;

FIG. 11 illustrates an operation of controlling an electronic device to perform an operation corresponding to a selected object according to an embodiment of the disclosure;

FIG. 12 illustrates an operation of controlling an electronic device or an external electronic device to perform an operation related to a notification of a media streaming application according to an embodiment of the disclosure; and

FIG. 13 illustrates an operation of controlling an electronic device or an external electronic device to perform an operation related to a notification of a browser application according to an embodiment of the disclosure.

The same reference numerals are used to represent the same elements throughout the drawings.

### DETAIL DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

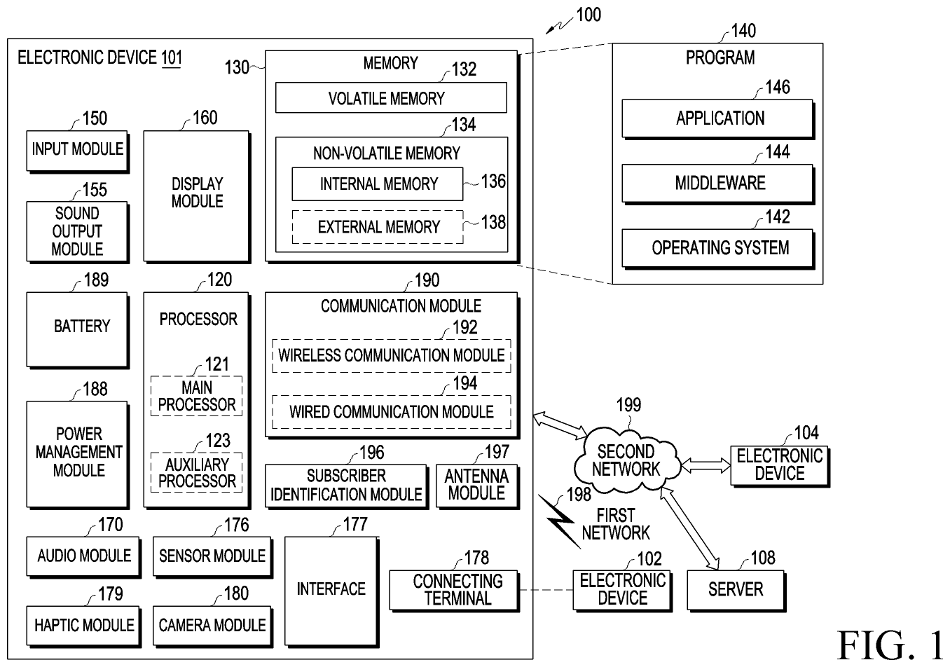

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

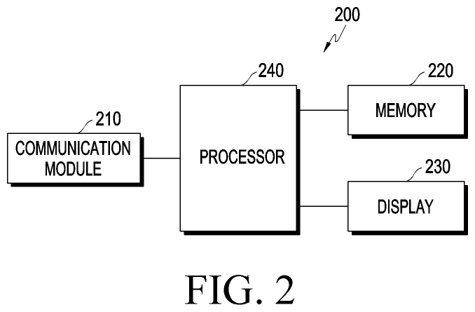

FIG. 2 is a block diagram of an electronic device 200 according to an embodiment of the disclosure.

Referring to FIG. 2, in an embodiment, the electronic device 200 may include a communication module 210, memory 220, a display 230, and a processor 240.

In an embodiment, the communication module 210 may be included in the communication module 190 of FIG. 1. In an embodiment, the electronic device 200 may communicate with an external electronic device (e.g., the electronic device 102 of FIG. 1) through the communication module 210.

In an embodiment, memory 220 may be included in the memory 130 of FIG. 1.

In an embodiment, the memory 220 may store information for performing at least one operation related to a notification. Information stored by the memory 220 will be described later.

In an embodiment, the display 230 may be included in the display module 160 of FIG. 1.

In an embodiment, the display 230 may display a notification obtained from an external electronic device (e.g., the electronic device 102 of FIG. 1). For example, the display 230 may display a notification about a new message obtained from the external electronic device (e.g., the electronic device 102 of FIG. 1).

In an embodiment, the processor 240 may be included in the processor 120 of FIG. 1.

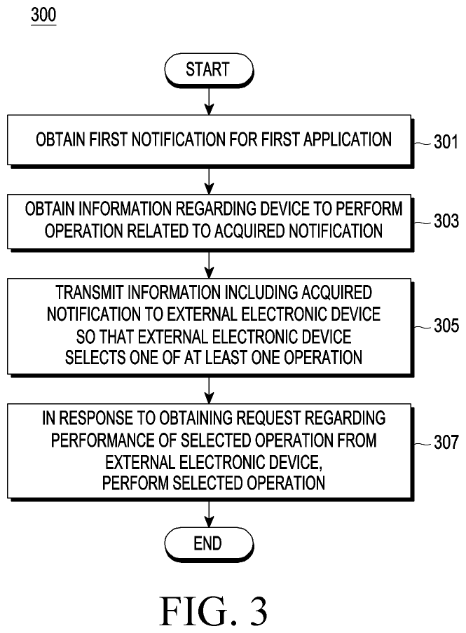

In an embodiment, the processor 240 may control overall operations to perform at least one operation related to a notification. In an embodiment, the processor 240 may include one or more processors to perform at least one operation related to the notification. Operations performed by the processor 240 in relation to notifications will be described later with reference to FIGS. 3 to 13.

In FIG. 2, the electronic device 200 is illustrated as including the communication module 210, the memory 220, the display 230, and/or the processor 240, but is not limited thereto. For example, the electronic device 200 may further include at least one configuration shown in FIG. 1. For example, the electronic device 200 may further include the sound output module 155 that outputs sound in response to obtaining a notification. In an embodiment, the electronic device 200 may be a wearable device that may be worn on a part of a user's body. For example, the electronic device 200 may include a smart watch, smart glasses, or a head mounted display (HMD) including the display 230. In an embodiment, the electronic device 200 may be a portable device that may be carried by the user even when not worn on a part of the user's body.

FIG. 3 is a flowchart 300 illustrating a method for performing an operation related to a notification according to an embodiment of the disclosure.

Referring to FIG. 3, in operation 301, in an embodiment, an electronic device (e.g., the electronic device 102 of FIG. 1) may obtain (or generate) a notification for a first application. In an embodiment, the electronic device 102 may be an electronic device, such as a smartphone, tablet personal computer (PC), laptop, smart television (TV), desktop, or wearable device, capable of performing operations based on applications. In an embodiment, the first application may be at least one program (e.g., the application 146 of FIG. 1) pre-stored in memory (not shown) of the electronic device 102. For example, the first application may include a messaging application, a media streaming application, or a browser application. The first application is not limited to the examples described above. In an embodiment, the electronic device 102 may obtain a new message from a server (e.g., server 108 of FIG. 1) when the first application is the messaging application. In an embodiment, the electronic device 102 may display a notification about the new message on the display. In an embodiment, when the first application is a calendar application, the electronic device 102 may obtain (or generate) a notification regarding a schedule pre-stored in memory.

In operation 303, in an embodiment, the electronic device 102 may obtain (or generate) information about a device to perform at least one operation related to the obtained notification. For example, when the notification obtained by the electronic device 102 is a notification about the new message for the messaging application, at least one operation related to the notification may include at least one of the following operations, such as calling a message sender, sending an emoji, and replying. The at least one operation related to the notification is not limited to the examples described above. In an embodiment, the electronic device 102 may obtain (or generate) information about a device to perform at least one operation related to a notification of a new message. The device to perform the at least one operation may be an external electronic device 200 (e.g., the electronic device 101 of FIG. 1) or the electronic device 102. For example, information about a device to perform at least one operation related to a notification may include a parameter for designating a device to perform the operation. In an embodiment, when a parameter has a value designating the electronic device 102, an operation related to a notification may be performed by the electronic device 102. In an embodiment, when the parameter has a value designating the external electronic device 200, an operation related to a notification may be performed by the external electronic device 200. In an embodiment, when the parameter has a value indicating to determine a device to perform the operation according to a user input, the operation related to a notification may be performed by a device (e.g., the electronic device 102 or the external electronic device 200) determined according to the user input. In an embodiment, when the parameter has a value indicating to determine a device to perform the operation, based on the state and operation pattern of the external electronic device 200, the operation related to the notification may be performed by a device (e.g., the electronic device 102 or the external electronic device 200) determined based on the state and operation pattern of the external electronic device 200.

The format of information about a device to perform at least one operation related to a notification may be defined within an application programming interface (API) (e.g., the program 140 of FIG. 1). In an embodiment, the API (e.g., the program 140 of FIG. 1) may be a function library for exchanging information between an operating system (e.g., the operating system 142 of FIG. 1) and an application (e.g., the application 146 of FIG. 1).

In an embodiment, the API may be a public API that is distributable on the Android platform. The public API may include a class (e.g., Notification.WearableExtender) for performing notification synchronization to a wearable device, a class (e.g., Notification.Action) for adding an operation related to a notification, and a method (e.g., Action) for designating information about an operation related to a notification. The number of operations related to a notification that is addable may be limited by considering the size of data for providing the notification. The method for designating information for an operation related to a notification may include parameters that designate an icon, a title, and an operation intent of the notification, and a device (ActionTarget device) to perform the operation related to the notification. In an embodiment, the public API may include a class (e.g., PendingIntent) that enables a selected operation to be performed in connection with the notification. In an embodiment, ease of application development may be enhanced when the format of the information about the device to perform the operation related to the notification is defined according to the public API. In an embodiment, not only a device (e.g., the electronic device 102) that has first acquired the notification, but also a device with which the notification has been shared (e.g., the external electronic device 200) may perform operations related to notifications by referring to information, the format of which is predefined according to the public API.

In an embodiment, the API may be a private API distributable on a platform provided by the manufacturer of a device (e.g., the electronic device 102 and the external electronic device 200). The private API may include a parameter for designating a class (e.g., Notification.Builder) for performing notification synchronization, a method (e.g., addExtras) for adding actions, and a device (e.g., Bundle extras) to perform an operation related to a notification for a first application. In an embodiment, the criteria for determining a device to perform an operation related to a notification may be designated by a parameter value (e.g., an extras value) determined in the process of developing an application. In an embodiment, a parameter for designating a device to perform an operation may be added to the private API defined by the manufacturer platform without changing the format of the API, so that other platforms may designate a device to perform the operation. The format of the API is not limited to the examples described above.

In operation 305, in an embodiment, the electronic device 102 may transmit information related to the acquired notification to the external electronic device 200, so that the external electronic device 200 selects one of at least one operation related to the notification. For example, the electronic device 102 may transmit, to the external electronic device 200, information including a new message and parameters for designating a device to perform the operation related to the new message. In an embodiment, the electronic device 102 may transmit a control signal to control the external electronic device 200. The operation of the electronic device 102 transmitting a notification to the external electronic device 200 may be referred to as “synchronization”. In an embodiment, the electronic device 102 may transmit information related to the acquired notification to multiple external electronic devices 200. When the electronic device 102 transmits information related to the acquired notification to the multiple external electronic devices 200, an operation related to the notification may be performed by the electronic device 102 or the multiple external electronic devices 200.

In an embodiment, an electronic device (e.g., the electronic device 102) that transmits a notification of an application may be referred to as a “source device” or a “primary device”. A device that obtains a notification of an application from the primary device (e.g., the external electronic device 200) may be referred to as a “secondary device”. For example, when the electronic device 102 transmits information related to a notification of a new message to the external electronic device 200, the electronic device 102 is a primary device and the external electronic device 200 is a secondary device. In an embodiment, an electronic device (electronic device 102 or external electronic device 200) that performs an operation related to a notification may be referred to as a “target device”. For example, when the external electronic device 102 performs an operation of replying to a message sender, based on information related to the notification of a new message obtained from the electronic device 200, the external electronic device 200 may be a target device.

In operation 307, in an embodiment, the electronic device 102 may obtain, from the external electronic device 200, a request regarding performance of the operation selected by the external electronic device 200. The electronic device 102 may perform the operation selected by the external electronic device 200 in response to obtaining the request. In an embodiment, the external electronic device 200 may request the electronic device 102 to perform a reply operation by referring to information related to a notification of a new message. When the electronic device 102 performs an operation of replying to the message sender, based on the obtained request, the electronic device 102 may be both a source device and a target device.

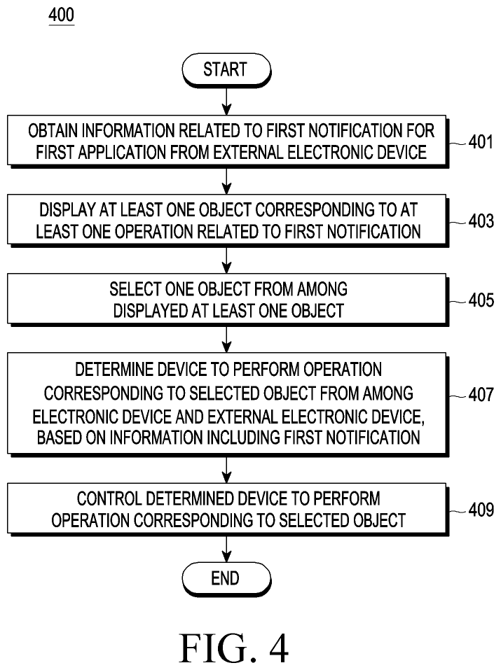

FIG. 4 is a flowchart 400 illustrating a method in which the electronic device 200 performs an operation related to a notification obtained from the external electronic device 102 according to an embodiment of the disclosure.

Referring to FIG. 4, in operation 401, in an embodiment, the processor 240 may obtain information related to a first notification for a first application from the external electronic device 102. In an embodiment, the first application may be a program that is not stored in memory 220. In an embodiment, the first application may be a program (e.g., application 146 of FIG. 1) stored in memory. A mode in which the first application is installed and operates in each of the memory of the external electronic device 102 and the memory 220 of the electronic device 200 may be referred to as a “companion mode”. In an embodiment, when the first application is stored in the electronic device 200, the processor 240 may obtain the first notification for the first application by using the first application. For example, when the first application is stored in the memory 220, the processor 240 directly executes the first application and obtains the first notification, based on data obtained from the external electronic device 102.

In operation 403, in an embodiment, the processor 240 may display at least one object corresponding to at least one operation related to the first notification of the first application through the display 230. For example, when the first notification is a notification of a new message for a messaging application, the processor 240 may display, on at least a portion of the display 230, a screen including at least one object corresponding to at least one operation related to the first notification. At least one operation related to a notification of a new message may include at least one of operations such as, operating a messaging application, calling a message sender, sending an emoji to the message sender, and transmitting a reply to the message sender. At least one operation related to the notification of the new message is not limited to the examples described above. The object corresponding to the operation related to the notification may be a button displayed on at least a portion of the display 230.

In operation 405, in an embodiment, the processor 240 may select one object from at least one object corresponding to at least one operation related to the first notification. In an embodiment, the processor 240 may, in response to a user input for at least one object displayed on the display 230, select an input object so that an operation corresponding to the object is performed. For example, the user input may be provided by an operation of touching an object displayed on the display 230. The user input is not limited to the examples described above. For example, the processor 240 may select an operation of calling the message sender as the operation to be performed in relation to the first notification, in response to a user input for an object corresponding to the operation of calling the message sender.

In operation 407, in an embodiment, based on information (e.g., ActionTarget device) including the first notification, the processor 240 may determine, among the electronic device 200 and the external electronic device 102, a device to perform an operation corresponding to a selected object. For example, when the operation of calling the sender for a notification of a new message is selected, the processor 240 may refer to a parameter value included in the information related to the first notification.

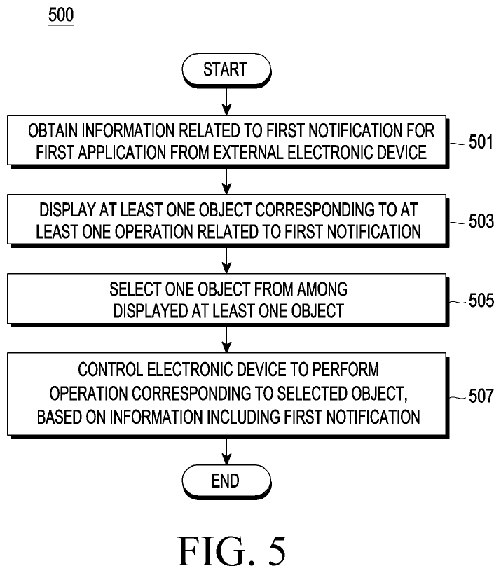

In operation 409, in an embodiment, the processor 240 may control the determined device to perform an operation corresponding to the selected object. An embodiment in which the processor 240 controls a device (the electronic device 200 or external electronic device 102) determined according to a parameter value to perform a selected operation will be described later with reference to FIGS. 5 to 8. The processor 240 controls the device (the electronic device 200 or external electronic device 102) determined according to the parameter value to perform the selected operation, and thus not only a device that first obtained a notification but also a device with which the notification has been shared may perform an operation related to the notification. Since the device (the electronic device 200 or external electronic device 102) performs an operation related to the notification, based on the parameter value included in the information related to the notification shared between heterogeneous devices, the effectiveness of notifications obtained from the external electronic device 102 may be improved.

FIG. 5 is a flowchart 500 illustrating an operation of controlling the electronic device 200 to perform an operation corresponding to a selected object according to an embodiment of the disclosure.

In operation 501, in an embodiment, the processor 240 may obtain information related to a first notification for a first application from the external electronic device 102. Since operation 501 is at least partially the same or similar to operation 401, detailed description will be omitted.

In operation 503, in an embodiment, the processor 240 may display at least one object corresponding to at least one operation related to the first notification of the first application through the display 230. Since operation 503 is at least partially the same or similar to operation 403, detailed description will be omitted.

In operation 505, in an embodiment, the processor 240 may select one object from at least one object corresponding to at least one operation related to the first notification. Since operation 505 is at least partially the same or similar to operation 405, detailed description will be omitted.

In operation 507, in an embodiment, the processor 240 may control the electronic device 200 to perform an operation corresponding to the selected object, based on information including the first notification. In an embodiment, the processor 240 may refer to a parameter (e.g., ActionTarget device) of information including the first notification. When a parameter value designating a device to perform the operation corresponding to the selected object is a value designating the electronic device 200, the processor 240 may control the electronic device 200 to perform the selected operation. In an embodiment, when the first application is a messaging application, operations related to a notification of a new message may include calling a message sender, sending an emoji to the message sender, or transmitting a reply to the message sender. In an embodiment, in response to referencing a parameter value designating the electronic device 200 as a device to perform the operation, the processor 240 may control the electronic device 200 to perform an operation related to a notification of a new message.

In an embodiment, the processor 240 may determine whether the electronic device 200 is capable of performing an operation corresponding to the selected object. For example, when an application capable of performing the operation corresponding to the selected object is not stored in the memory 220, the processor 240 may determine that the electronic device is unable to perform the operation corresponding to the selected object. When the electronic device 200 is unable to perform an operation corresponding to the selected object, the processor 240 may request the external electronic device 102 to perform an operation corresponding to the selected object. According to an embodiment, in order to perform an operation corresponding to the selected object, the processor 240 may execute a second application configured to provide a feature related to the selected object. For example, when the first application is a messaging application, the plurality of second applications may include at least one of a phone application, a media streaming application, or a calendar application. In an embodiment, when the plurality of second applications configured to provide the function related to the selected object are identified, the processor 240 may display a plurality of objects corresponding to the plurality of second applications through the display. The processor 240 may perform an operation corresponding to the selected object, by using the second application corresponding to the selected object of the plurality of second applications, in response to a user input for one of the displayed plurality of objects. The processor 240 may control the device (the electronic device 200 or external electronic device 102) determined according to a parameter value to perform the selected operation, so that not only a device that first obtained a notification but also a device with which the notification has been shared may perform an operation related to the notification.

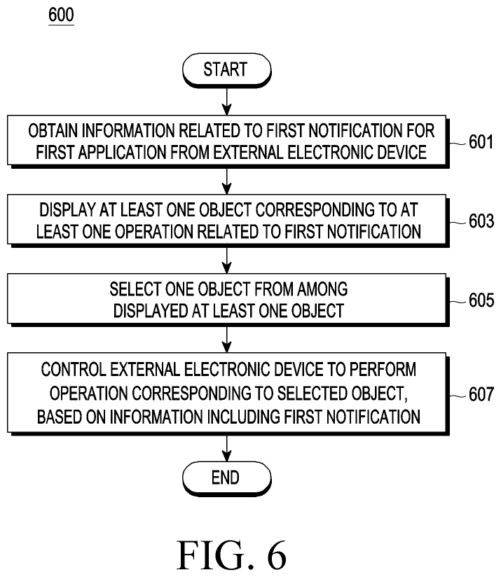

FIG. 6 is a flowchart 600 illustrating an operation in which the electronic device 200 requests the external electronic device 102 to perform an operation corresponding to a selected object according to an embodiment of the disclosure.

In operation 601, in an embodiment, the processor 240 may obtain information related to a first notification for a first application from the external electronic device 102. Since operation 601 is at least partially the same or similar to operation 401, detailed description will be omitted.

In operation 603, in an embodiment, the processor 240 may display at least one object corresponding to at least one operation related to the first notification through the display 230. Since operation 603 is at least partially the same or similar to operation 403, detailed description will be omitted.

In operation 605, in an embodiment, the processor 240 may select one object from the displayed at least one object. Since operation 605 is at least partially the same or similar to operation 405, detailed description will be omitted.

In operation 607, in an embodiment, the processor 240 may control the external electronic device 102 to perform an operation corresponding to the selected object, based on information including the first notification. In an embodiment, the processor 240 may refer to a parameter (e.g., ActionTarget device) of information including the first notification. When a parameter value designating a device to perform the operation corresponding to the selected object is a value designating the external electronic device 102, the processor 240 may request the external electronic device 102 to perform the selected operation. In an embodiment, the external electronic device 102 may obtain a request for performing a selected operation from the electronic device 200. The external electronic device 102 may perform the operation selected by the electronic device 200 in response to obtaining the request.

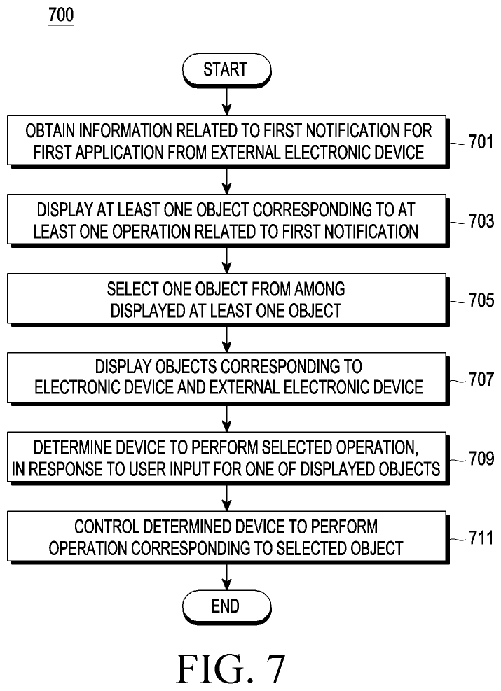

FIG. 7 is a flowchart 700 illustrating an operation of determining a device to perform an operation related to a notification, based on a user input according to an embodiment of the disclosure.

In operation 701, in an embodiment, the processor 240 may obtain information related to a first notification for a first application from the external electronic device 102. Since operation 701 is at least partially the same or similar to operation 401, detailed description will be omitted.

In operation 703, in an embodiment, the processor 240 may display at least one object corresponding to at least one operation related to the first notification through the display 230. Since operation 703 is at least partially the same or similar to operation 403, detailed description will be omitted.

In operation 705, in an embodiment, the processor 240 may select one object from the displayed at least one object. Since operation 705 is at least partially the same or similar to operation 405, detailed description will be omitted.

In operation 707, in an embodiment, the processor 240 may display objects corresponding to the electronic device 200 and the external electronic device 102. In an embodiment, the processor 240 may refer to a parameter (e.g., ActionTarget device) of information including the first notification. When a parameter value designating a device to perform the operation corresponding to the selected object is a value indicating to determine a device to perform the operation according to a user input, the processor 240 may display objects corresponding to the electronic device 200 and the external electronic device 102, respectively, through the display 230. For example, the user input may be provided by an operation of touching an object corresponding to one of at least one device included in a list displayed on the display 230. In an embodiment, the object corresponding to a device may be implemented in the form of a button.

In operation 709, in an embodiment, the processor 240 may determine a device to perform the selected operation, in response to a user input for one of the displayed objects. In an embodiment, the processor 240 may determine the electronic device 200 as a device to perform the selected operation in response to a user input for an object corresponding to the electronic device 200. In an embodiment, the processor 240 may determine the external electronic device 102 as a device to perform the selected operation in response to a user input for an object corresponding to the external electronic device 102.

In operation 711, in an embodiment, the processor 240 may control the determined device to perform an operation corresponding to the selected object. In an embodiment, when the electronic device 200 is determined to perform the selected operation, the processor 240 may control the electronic device 200 to perform the operation corresponding to the selected object. In an embodiment, when the external electronic device 102 is determined to perform the selected operation, the processor 240 may request the external electronic device 102 to perform the operation corresponding to the selected object. In response to the user input, the processor 240 may control not only a device that first obtained a notification (e.g., the external electronic device 102) but also a device with which the notification has been shared (e.g., the electronic device 200) to perform an operation related to the notification. In an embodiment, the electronic device 200 or the external electronic device 102 may perform an operation related to a notification, based on a user input, whereby the usability of notifications shared between the external electronic device 102 and the electronic device 200 may be improved.

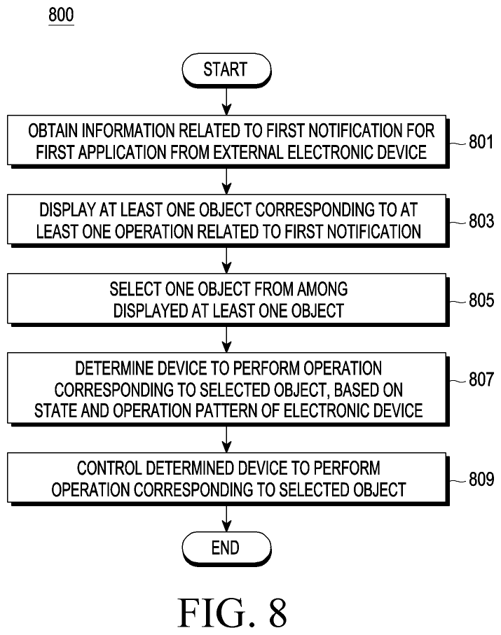

FIG. 8 is a flowchart 800 illustrating an operation of determining a device to perform an operation related to a notification, based on the state and operation pattern of the electronic device 200 according to an embodiment of the disclosure.

In operation 801, in an embodiment, the processor 240 may obtain information related to a first notification for a first application from the external electronic device 102. Since operation 801 is at least partially the same or similar to operation 401, detailed description will be omitted.

In operation 803, in an embodiment, the processor 240 may display at least one object corresponding to at least one operation related to the first notification through the display 230. Since operation 803 is at least partially the same or similar to operation 403, detailed description will be omitted.

In operation 805, in an embodiment, the processor 240 may select one object from the displayed at least one object. Since operation 805 is at least partially the same or similar to operation 405, detailed description will be omitted.

In operation 807, in an embodiment, the processor 240 may determine a device to perform an operation corresponding to the selected object, based on the state and operation pattern of the electronic device. In an embodiment, the processor 240 may refer to a parameter (e.g., ActionTarget device) of information including the first notification. When the parameter value is a value designating a device to perform the operation, based on the state and operation pattern of the electronic device 200, the processor 240 may determine a device to perform the selected operation.

In an embodiment, the state of the electronic device 200 may include the remaining battery capacity of the electronic device 200 or a network state between the electronic device 200 and the external electronic device 102. For example, when the remaining battery capacity of the electronic device 200 is equal to or less than a preconfigured numeric value or when the network connection with the external electronic device 102 is released, the processor 240 may determine the electronic device 200 as a device to perform the selected operation. In an embodiment, the operation pattern of the electronic device 200 may include information about a device that has a history of performing selected operations multiple times between the electronic device 200 and the external electronic device 102. For example, when there is a history of the selected operation being performed primarily on the electronic device 200, the processor 240 may determine the electronic device 200 as a device to perform the selected operation. In an embodiment, the processor 240 may determine a device (the electronic device 200 or external electronic device 102) to perform the selected operation, based on usage patterns regarding the operation history of the electronic device 200 and the real-time resource state of the electronic device 200.

In operation 809, in an embodiment, the processor 240 may control the determined device to perform an operation corresponding to the selected object. In an embodiment, when the electronic device 200 is determined to perform the selected operation, the processor 240 may control the electronic device 200 to perform the operation corresponding to the selected object. In an embodiment, when the external electronic device 102 is determined to perform the selected operation, the processor 240 may request the external electronic device 102 to perform the operation corresponding to the selected object. The processor 240 may adaptively determine a device to perform an operation related to a notification, based on the state and usage pattern of the electronic device 200. In an embodiment, a device determined by the processor 240 may perform an operation related to a notification, thereby improving the usability of notifications shared between the external electronic device 102 and the electronic device 200.

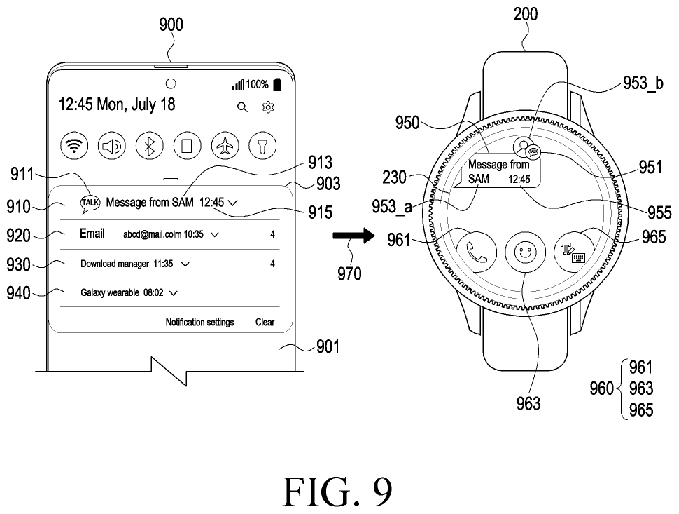

FIG. 9 illustrates a notification shared between the electronic device 200 and an external electronic device 900 and operations related to the notification according to an embodiment of the disclosure.

Referring to FIG. 9, an external electronic device 900 (e.g., the external electronic device 102 of FIG. 1) may obtain (or generate) a notification for at least one first application. For example, the notification for the at least one first application may include at least one of a notification 910 of a new message for a messaging application, a notification 920 of receiving an email for an email application, a notification 930 for a download management application, and a notification 940 for a wearable device. Notifications for the first application are not limited to the examples described above. In an embodiment, the external electronic device 900 may display a notification for the at least one first application on at least a portion of the display 901. For example, the external electronic device 900 may display the notifications 910, 920, 930, and 940 for at least one first application in a notification window 903. The screen on which the external electronic device 900 displays notifications is not limited to the example shown in FIG. 9. In an embodiment, the notification 910 of a new message for the messaging application may include information about an icon 911 of the messaging application, an ID 913 of a message sender, and a message reception time 915. The information included in the notification 910 of a new message is not limited to the examples described above.

In an embodiment, the external electronic device 900 may transmit information related to a first notification 910 regarding at least one of the obtained notifications 910, 920, 930, and 940 to the electronic device 200 (e.g., the external electronic device 101 of FIG. 1) (indicated by reference numeral 970). Information related to the first notification 910 may include a parameter for designating a device to perform at least one operation related to a notification. In an embodiment, the electronic device 200 may perform pairing to communicate with the external electronic device 102. In an embodiment, pairing may be an operation of connecting a communication path between the devices. In an embodiment, the external electronic device 900 may perform at least one operation related to a notification, in response to a user input. For example, the external electronic device 900 may perform an operation of identifying content of the message, in response to a user input for the notification 910 of a new message.

In an embodiment, the processor 240 may display a first notification 950 obtained from the external electronic device 900 (e.g., the electronic device 102 of FIG. 1) through the display 230 (e.g., the display module of FIG. 1). The first notification 950 displayed on the display 230 may include information about the messaging application icon 911, a message sender ID 953_a, 953b, and a message reception time 955. The information included in the first notification 950 is not limited to the examples described above. The processor 240 may display an object 960 corresponding to at least one operation related to the first notification on at least a portion of the display 230. An object 960 corresponding to at least one operation related to the first notification may include at least one of an object 961 corresponding to an operation of calling the message sender, an object 963 corresponding to an operation of sending an emoji, or an object 965 corresponding to an operation of replying. The at least one operation related to the first notification is not limited to the examples described above. In an embodiment, at least one of the objects 960 shown in FIG. 9 may be changed to at least one of an object corresponding to an operation of running the messaging application, an object corresponding to an operation of changing to the message read state, an object corresponding to an operation of deleting a notification, and an object corresponding to an operation of storing a notification.

In an embodiment, a screen displayed on the display 230 of the electronic device 200 shown in FIG. 9 may be a screen of an extended notification displayed, by the processor 240, on the display 230, in response to a user input for the first notification 950 displayed in a notification stream. In an embodiment, the notification stream may be a screen in which, when the electronic device 200 acquires multiple notifications, the acquired notifications are displayed on the display 230 in the order in which the notifications were acquired. The extended notification may include information 951, 953_a, 953_b, and 955 associated with the first notification 950 and at least one object 960 corresponding to an operation associated with the first notification. For example, information regarding a profile image 953_b of the message sender may not be displayed in the notification stream, but may be displayed in an extended notification based on a user input. In an embodiment, when there is only one operation associated with the first notification 950, the notification screen displayed on the display 230 may be a screen for an inline action.

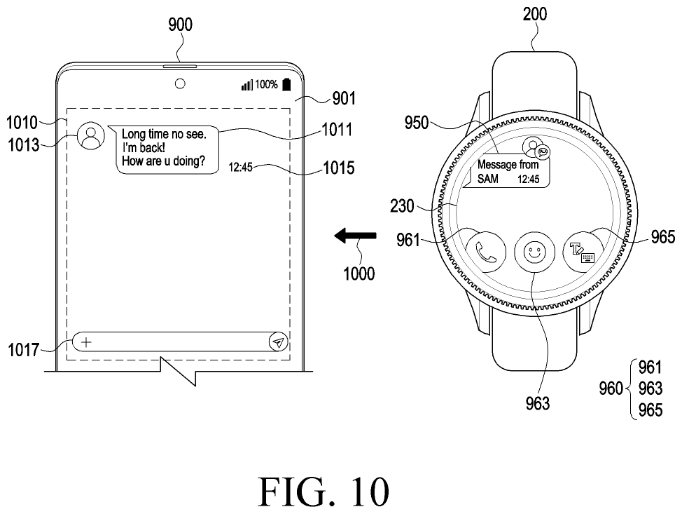

FIG. 10 illustrates an operation in which the electronic device 200 requests an external electronic device 900 (e.g., the electronic device 102 of FIG. 1) to perform an operation corresponding to a selected object according to an embodiment of the disclosure.

In an embodiment, the processor 240 may select one object from at least one object 960 related to the first notification 950. In an embodiment, the processor 240 may, in response to a user input for at least one object 960 displayed on the display 230, select an input object so that an operation corresponding to the object is performed. For example, the user input may be provided by an operation of touching an object displayed on the display 230. The user input is not limited to the examples described above. For example, the processor 240 may, in response to a user input for an object 965 corresponding to an operation of replying to a message sender, select the operation of replying to the message sender as an operation to be performed in connection with the first notification 950.

In an embodiment, in case that a value of a parameter (e.g., ActionTarget device) of the information including the first notification 950 is a value designating the external electronic device 900, the processor 240 may determine the external electronic device 900 as a device to perform the operation of replying to the message sender.

In an embodiment, in case that a parameter value designating a device to perform the selected operation is a value indicating to determine a device to perform the operation according to a user input, the processor 240 may display objects corresponding to the electronic device 200 and the external electronic device 900 through the display 230. In an embodiment, the processor 240 may determine the external electronic device 900 as a device to perform the selected operation, in response to a user input for an object corresponding to the external electronic device 900.

In an embodiment, in case that a parameter value designating a device to perform the selected operation is a value indicating to determine a device to perform the operation based on the state and operation pattern of the electronic device 200, the processor 240 may determine a device to perform the selected operation based on the state and operation pattern of the electronic device 200. In an embodiment, in case that the remaining battery capacity of the electronic device 200 is equal to or less than a preconfigured numeric value and there is a history of the selected operation being performed multiple times by the external electronic device 900, the processor 240 may determine the external electronic device 900 as a device to perform the selected operation.

In an embodiment, the processor 240 may request the external electronic device 900 to perform the operation corresponding to the selected object 961 (indicated by reference numeral 1000). In an embodiment, after requesting the external electronic device 900 to perform the operation corresponding to the selected object 961 (indicated by reference numeral 1000), the processor 240 may provide a notification indicating that the operation corresponding to the selected object 961 is being performed. In an embodiment, the external electronic device 900 may display an execution screen 1010 of an operation of replying to the message sender on the display 901, in response to obtaining the request from the electronic device 200. In an embodiment, the execution screen 1010 may include a new message content 1011, a sender's profile image 1013, a message reception time 1015, and a message input window 1017. The information included in the execution screen 1010 is not limited to the examples described above. In an embodiment, the external electronic device 900 may perform an operation of replying to the message sender, in response to a reply message input into the message input window 1017.

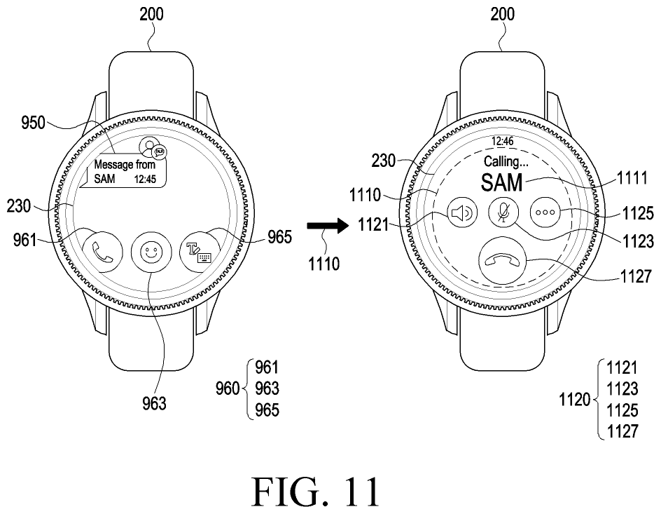

FIG. 11 illustrates an operation of controlling the electronic device 200 to perform an operation corresponding to a selected object according to an embodiment of the disclosure.

In an embodiment, the processor 240 may select one object from at least one object 960 related to the first notification 950. In an embodiment, the processor 240 may, in response to a user input for at least one object 960 displayed on the display 230, select an input object so that an operation corresponding to the object is performed. For example, the user input may be provided by an operation of touching an object displayed on the display 230. The user input scheme is not limited to the examples described above. For example, the processor 240 may, in response to a user input for an object 961 corresponding to an operation of calling a message sender, select an operation of calling the message sender as an operation to be performed in connection with the first notification 950.

In an embodiment, the processor 240 may refer to a parameter (e.g., ActionTarget device) of information including the first notification 950. In an embodiment, in case that a parameter value designating a device to perform the selected operation is a value designating the electronic device 200, the processor 240 may determine the electronic device 200 as a device to perform the operation of replying to the message sender.

In an embodiment, in case that a parameter value designating a device to perform the selected operation indicates to determine a device according to a user input, and in case that the parameter value is a value indicating to determine a device to perform the operation according to a user input, the processor 240 may display objects corresponding to the electronic device 200 and the external electronic device 900, respectively, through the display 230. In an embodiment, the processor 240 may determine the electronic device 200 as a device to perform the selected operation, in response to a user input for an object corresponding to the electronic device 200.

In an embodiment, in case that a parameter value designating a device to perform the selected operation is a value indicating to determine a device to perform the operation based on the state and operation pattern of the electronic device 200, the processor 240 may determine a device to perform the selected operation based on the state and operation pattern of the electronic device 200. In an embodiment, in response to identifying that the electronic device 200 is in a state capable of performing the selected operation, and that there is a history of the selected operation being performed multiple times by the electronic device 200, the processor 240 may determine the electronic device 200 as a device to perform the selected operation.

In an embodiment, the processor 240 may control the electronic device 200 to perform the operation corresponding to the selected object 961 (indicated by reference numeral 1100). For example, the processor 240 may execute a phone application and display an execution screen 1110 of an operation of calling the message sender on at least a portion of the display 230. In an embodiment, an application (e.g., a phone application) being executed to perform an operation related to a first notification for a first application (e.g., a messaging application) may be referred to as a “second application”. The execution screen 1110 may include information about a call recipient 1111 and at least one object 1120 corresponding to at least one additional operation related to the calling operation. At least one object 1120 corresponding to the at least one additional operation may include a volume control button 1121, a mute button 1123, an additional option button 1125, and a call end button 1127. For example, the additional option button 1125 may be an object for displaying a virtual keypad (not shown). An object corresponding to an additional operation is not limited to the examples described above. In an embodiment, even in case that the first application is not stored in the memory 220, the processor 240 may control the electronic device 200 to perform at least one operation related to the first notification 950, based on the first notification 950 obtained from the external electronic device 900.

In an embodiment, the processor 240 may display at least one object 960 corresponding to at least one operation related to the notification 950. The processor 240 may, in response to a user input, select one (e.g., a call button 961) of the displayed at least one object 960 and perform a control such that the operation corresponding to the selected object 961 is performed (indicated by reference numeral 1100). The processor 240 may display at least one object 1120 corresponding to an additional operation related to the selected operation on at least a portion of the display 230. The processor 240 may control to perform an additional operation corresponding to the user input, in response to a user input for at least one object 1120 corresponding to the additional operation. In an embodiment, the processor 240 may, when the messaging application is not stored in the memory 220, request the external electronic device 900 to perform an operation related to a notification. For example, the processor 240 may request the external electronic device 900 to perform the selected operation using the messaging application, in response to a user input for an object corresponding to an operation requiring execution of the messaging application.

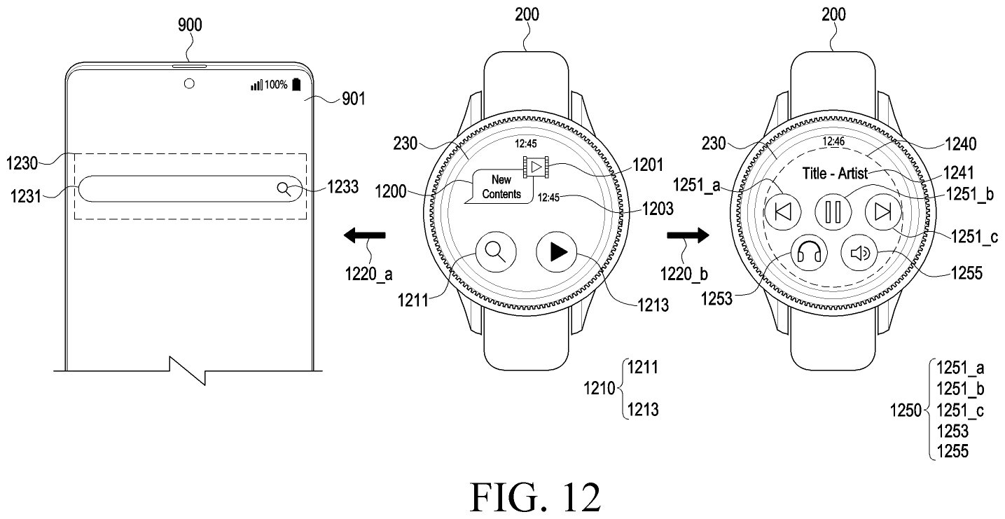

FIG. 12 illustrates an operation of controlling the electronic device 200 or the external electronic device 900 to perform an operation related to a notification of a media streaming application according to an embodiment of the disclosure.

In an embodiment, the electronic device 200 may display information related to a first notification 1200 for a media streaming application obtained from the external electronic device 900 through the display 230. In an embodiment, the first notification 1200 may be a recommendation notification for new content. The first notification 1200 displayed on the display 230 may include a media streaming application icon 1201 and information about a notification reception time 1203. The information included in the first notification 1200 is not limited to the examples described above. The processor 240 may display an object 1210 corresponding to at least one operation related to the first notification 1200 on at least a portion of the display 230. The object 1210 corresponding to at least one operation related to the first notification may include at least one of an object 1211 corresponding to an operation of searching for recommended media content and an object 1213 corresponding to an operation of playing recommended media content. At least one operation related to the first notification 1200 is not limited to the examples described above.

In an embodiment, a screen displayed on the display 230 of the electronic device 200 shown in FIG. 12 may be a screen of an extended notification displayed on the display 230 by the processor 240, in response to a user input for the first notification 1200 displayed in a notification stream. In an embodiment, the notification stream may be a screen in which, when the electronic device 200 acquires multiple notifications, the acquired multiple notifications are displayed on the display 230 in the order in which the notifications were acquired. The extended notification may include information 1201 and 1203 related to the first notification 1200 and at least one object 1210 corresponding to an operation related to the first notification 1200. For example, at least one object 1210 corresponding to an operation related to the first notification 1200 may not be displayed in the notification stream, but may be displayed in the extended notification.

In an embodiment, the processor 240 may select one object from at least one object 1210 related to the first notification 1200. In an embodiment, the processor 240 may, in response to a user input for at least one object 1210 displayed on the display 230, select an input object so that an operation corresponding to the object is performed. For example, the user input may be provided by an operation of touching an object displayed on the display 230. The user input is not limited to the examples described above. For example, the processor 240 may, in response to a user input for the object 1211 corresponding to an operation of searching for media content, select the operation of searching for media content as an operation to be performed in relation to the first notification 1200.

In an embodiment, in case that a value of a parameter (e.g., ActionTarget device) of the information including the first notification 1200 is a value designating the external electronic device 900, the processor 240 may determine the external electronic device 900 as a device to perform the operation of searching for media content.

In an embodiment, in case that a parameter value designating a device to perform the selected operation is a value indicating to determine a device to perform the operation according to a user input, the processor 240 may display objects corresponding to the electronic device 200 and the external electronic device 900 through the display 230. In an embodiment, the processor 240 may determine the external electronic device 900 as a device to perform the selected operation, in response to a user input for an object corresponding to the external electronic device 900.

In an embodiment, in case that a parameter value designating a device to perform the selected operation is a value indicating to determine a device to perform the operation based on the state and operation pattern of the electronic device 200, the processor 240 may determine a device to perform the selected operation based on the state and operation pattern of the electronic device 200. In an embodiment, in case that the remaining battery capacity of the electronic device 200 is equal to or less than a preconfigured numeric value and there is a history of the selected operation being performed multiple times by the external electronic device 900, the processor 240 may determine the external electronic device 900 as a device to perform the selected operation.

In an embodiment, the processor 240 may request the external electronic device 900 to perform the operation corresponding to the selected object 1211 (indicated by reference numeral 1220_a). In an embodiment, the external electronic device 900 may display an execution screen 1230 of an operation of searching for media content on the display 901 in response to obtaining the request from the electronic device 200. In an embodiment, the execution screen 1230 may include a media search window 1231 and a search object 1233. Information included in the execution screen 1230 is not limited to the examples described above. In an embodiment, the external electronic device 900 may perform an operation of searching for media content, in response to a user input to the media search window 1231 and the search object 1233.

In an embodiment, the processor 240 may, in response to a user input for an object 1213 corresponding to an operation of playing media content, select the operation of playing media content as an operation to be performed in relation to the first notification 1200.

In an embodiment, the processor 240 may refer to a parameter (e.g., ActionTarget device) of information including the first notification 1200. In an embodiment, in case that a parameter value designating a device to perform the selected operation is a value designating the electronic device 200, the processor 240 may determine the electronic device 200 as a device to perform the operation of playing media content.

In an embodiment, in case that a parameter value designating a device to perform the selected operation is a value indicating to determine a device to perform the operation according to a user input, the processor 240 may display objects corresponding to the electronic device 200 and the external electronic device 900 through the display 230. In an embodiment, the processor 240 may determine the electronic device 200 as a device to perform the selected operation, in response to a user input for an object corresponding to the electronic device 200.

In an embodiment, in case that a parameter value designating a device to perform the selected operation is a value indicating to determine a device to perform the operation based on the state and operation pattern of the electronic device 200, the processor 240 may determine a device to perform the selected operation based on the state and operation pattern of the electronic device 200. In an embodiment, in response to identifying that the electronic device 200 is in a state capable of performing the selected operation, and that there is a history of the selected operation being performed multiple times by the electronic device 200, the processor 240 may determine the electronic device 200 as a device to perform the selected operation.

In an embodiment, the processor 240 may control the electronic device 200 to perform the operation corresponding to the selected object 1213 (indicated by reference numeral 1220_b). For example, the processor 240 may execute a media streaming application and display an execution screen 1240 for playing media content corresponding to the notification on at least a portion of the display 230. The execution screen 1240 may include information 1241 about media content and at least one object 1250 corresponding to at least one additional operation related to the operation of playing media content. At least one object 1150 corresponding to the at least one additional operation may include a previous media content play button 1251_a, a pause button 1251_b, a previous media content play button 1251_c, and an audio output device selection button 1253, and a volume control button 1255. Objects corresponding to additional operations are not limited to the examples described above. In an embodiment, the processor 240 may control an operation related to the first notification 1200 to be performed by the electronic device 200 using a parameter value of information obtained from the external electronic device 900. In an embodiment, the operation of the electronic device 200 has the effect of improving the usability of notifications shared between the external electronic device 900 and the electronic device 200.

In an embodiment, in case that the media streaming application is not stored in the memory 220, the electronic device 200 may obtain an identifier of media content by referring to information including the first notification 1200. In an embodiment, the identifier of media content may be a uniform resource identifier (URI) capable of identifying media content. The electronic device 200 may, based on the acquired media content identifier, display at least one object corresponding to at least one application (e.g., a browser application) capable of playing media content, through the display 230. The electronic device 200 may, in response to a user input for one of the displayed objects, execute an application corresponding to the object. In an embodiment, the electronic device 200 may execute the selected operation using an application capable of executing an operation related to the first notification 1200 even when a first application is not stored in the memory 220. In an embodiment, an application that is executed to perform an operation related to the first notification 1200 for the first application (e.g., a media streaming application) may be referred to as a “second application”.

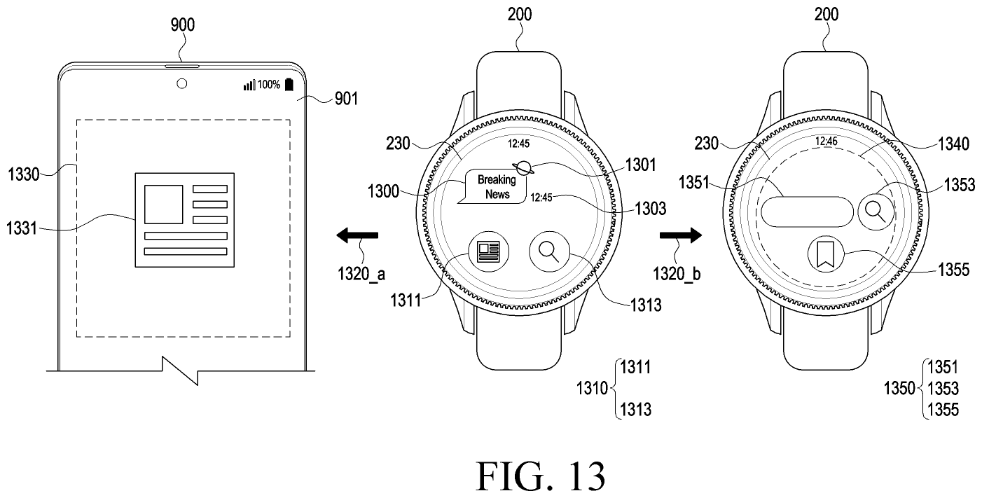

FIG. 13 illustrates an operation of controlling the electronic device 200 or the external electronic device 900 to perform an operation related to a notification of a browser application according to an embodiment of the disclosure.

In an embodiment, the electronic device 200 may display information related to a first notification 1300 for a browser application obtained from the external electronic device 900, through the display 230. In an embodiment, the first notification 1300 may be a recommendation notification for an article. The first notification 1300 displayed on the display 230 may include an icon 1301 of the browser application and information about a notification reception time 1303. The information included in the first notification 1300 is not limited to the examples described above. The processor 240 may display an object 1310 corresponding to at least one operation related to the first notification 1300 on at least a portion of the display 230. The object 1310 corresponding to at least one operation related to the first notification 1300 may include at least one of an object 1311 corresponding to an operation of identifying a recommended article and an object 1313 corresponding to a search operation. At least one operation related to the first notification 1300 is not limited to the examples described above.

In an embodiment, a screen displayed on the display 230 of the electronic device 200 shown in FIG. 13 may be a screen of an extended notification displayed, by the processor 240, on the display 230, in response to a user input for the first notification 1300 displayed in a notification stream. In an embodiment, the notification stream may be a screen in which, when the electronic device 200 acquires multiple notifications, the acquired multiple notifications are displayed on the display 230 in the order in which the notifications were acquired. The extended notification may include information 1301 and 1303 related to the first notification 1300 and at least one object 1310 corresponding to an operation related to the first notification 1300. For example, at least one object 1310 corresponding to an operation related to the first notification 1300 may not be displayed in the notification stream, but may be displayed in the extended notification.

In an embodiment, the processor 240 may select one object from at least one object 1310 related to the first notification 1300. In an embodiment, the processor 240 may, in response to a user input for at least one object 1310 displayed on the display 230, select an input object so that an operation corresponding to the object is performed. For example, the user input may be provided by an operation of touching an object displayed on the display 230. The user input is not limited to the examples described above. For example, the processor 240 may, in response to a user input for an object 1311 corresponding to an operation of identifying a recommended article, select the operation of identifying the recommended article as an operation to be performed in relation to the first notification 1300.

In an embodiment, in case that a value of a parameter (e.g., ActionTarget device) of the information including the first notification 1300 is a value designating the external electronic device 900, the processor 240 may determine the external electronic device 900 as a device to perform the operation of searching for media content.

In an embodiment, in case that a parameter value designating a device to perform the selected operation is a value indicating to determine a device to perform the operation according to a user input, the processor 240 may display objects corresponding to the electronic device 200 and the external electronic device 900 through the display 230. In an embodiment, the processor 240 may determine the external electronic device 900 as a device to perform the selected operation, in response to a user input for an object corresponding to the external electronic device 900.

In an embodiment, in case that a parameter value designating a device to perform the selected operation is a value indicating to determine a device to perform the operation based on the state and operation pattern of the electronic device 200, the processor 240 may determine a device to perform the selected operation, based on the state and operation pattern of the electronic device 200. In an embodiment, in case that the remaining battery capacity of the electronic device 200 is equal to or less than a preconfigured numeric value and there is a history of the selected operation being performed multiple times by the external electronic device 900, the processor 240 may determine the external electronic device 900 as a device to perform the selected operation.

In an embodiment, the processor 240 may request the external electronic device 900 to perform the operation corresponding to the selected object 1311 (indicated by reference numeral 1320_a). In an embodiment, the external electronic device 900 may display an execution screen 1330 of an operation of identifying a recommend article on the display 901 in response to obtaining the request from the electronic device 200. In an embodiment, the external electronic device 900 may execute a browser application. The external electronic device 900 may access the recommended article, based on the identifier (e.g., URI) of the recommended article. In an embodiment, the execution screen 1330 may include article content 1331. Information included in the execution screen 1330 is not limited to the examples described above.

In an embodiment, the processor 240 may, in response to a user input for an object 1313 corresponding to a searching operation, select the searching operation as an operation to be performed in relation to the first notification 1300.

In an embodiment, the processor 240 may refer to a parameter (e.g., ActionTarget device) of information including the first notification 1300. In an embodiment, in case that a parameter value designating a device to perform the selected operation is a value designating the electronic device 200, the processor 240 may determine the electronic device 200 as a device to perform the searching operation.

In an embodiment, in case that a parameter value designating a device to perform the selected operation is a value indicating to determine a device to perform the operation according to a user input, the processor 240 may display objects corresponding to the electronic device 200 and the external electronic device 900 through the display 230. In an embodiment, the processor 240 may determine the electronic device 200 as a device to perform the selected operation, in response to a user input for an object corresponding to the electronic device 200.

In an embodiment, in case that a parameter value designating a device to perform the selected operation is a value indicating to determine a device to perform the operation based on the state and operation pattern of the electronic device 200, the processor 240 may determine a device to perform the selected operation based on the state and operation pattern of the electronic device 200. In an embodiment, in response to identifying that the electronic device 200 is in a state capable of performing the selected operation, and that there is a history of the selected operation being performed multiple times by the electronic device 200, the processor 240 may determine the electronic device 200 as a device to perform the selected operation.

In an embodiment, the processor 240 may control the electronic device 200 to perform the operation corresponding to the selected object 1313 (indicated by reference numeral 1320_b). For example, the processor 240 may execute a browser application and display an execution screen 1340 of a search operation on at least a portion of the display 230. The execution screen 1340 may include at least one object 1350 corresponding to at least one additional operation related to the searching operation. At least one object 1350 corresponding to the at least one additional operation may include a search window execution button 1351, a search button 1353, and a bookmark execution button 1355. The object 1350 corresponding to the additional operation is not limited to the examples described above. In an embodiment, the processor 240 may control the electronic device 200 to perform an operation related to the first notification 1300 using a parameter value of information obtained from the external electronic device 900. In an embodiment, the operation of the electronic device 200 has the effect of improving the usability of notifications shared between the external electronic device 900 and the electronic device 200.

In an embodiment, in case that the first application (e.g., a browser application stored in the external electronic device 900) is not stored in the memory 220, the electronic device 200 may obtain an identifier of the recommend article by referring to information including the first notification 1300. In an embodiment, the identifier of the recommended article may be a uniform resource identifier (URI) capable of identifying a resource. The electronic device 200 may, based on the acquired article identifier, display at least one object corresponding to at least one application (e.g., a browser application different from the first application) capable of accessing the URI of the article, through the display 230. The electronic device 200 may, in response to a user input for one of the displayed objects, execute an application corresponding to the object. In an embodiment, the electronic device 200 may execute the selected operation using an application capable of executing an operation related to the first notification 1300 even when the first application is not stored in the memory 220. In an embodiment, an application (e.g., an application) that is executed to perform an operation related to the first notification 1300 for the first application may be referred to as a “second application”.

In an embodiment, an electronic device may include a communication module, a display, and at least one processor operatively connected to the display. The at least one processor may obtain information related to a first notification for a first application from an external electronic device through the communication module. The at least one processor may display at least one object corresponding to at least one operation related to the first notification through the display. The at least one processor may select one object from the displayed at least one object. The at least one processor may determine, among the electronic device and the external electronic device, a device to perform an operation corresponding to the selected object, based on information including the first notification. The at least one processor may be configured to control the determined device to perform the operation corresponding to the selected object.

In an embodiment, the at least one processor may display objects corresponding to the electronic device and the external electronic device through the display. The at least one processor may, in response to a user input for one of the displayed objects, determine, among the electronic device and the external electronic device, a device to perform the operation corresponding to the selected object. The at least one processor may be configured to control the determined device to perform an operation corresponding to the selected object.

In an embodiment, the at least one processor may determine, among the electronic device and the external electronic device, a device to perform the operation corresponding to the selected object, based on the state and operation pattern of the electronic device. The at least one processor may be configured to control the determined device to perform an operation corresponding to the selected object.

In an embodiment, the state of the electronic device may include the remaining battery capacity of the electronic device and a connection state with the external electronic device. The operation pattern may include a history of the electronic device performing an operation corresponding to the selected object.

In an embodiment, the at least one processor may be configured to, in case that the first application is stored in the electronic device, obtain the first notification for the first application by using the first application.

In an embodiment, the at least one processor may determine whether the electronic device is able to perform an operation corresponding to the selected object.

In an embodiment, the at least one processor may be configured to, in case that the electronic device is unable to perform an operation corresponding to the selected object, request the external electronic device to perform the operation corresponding to the selected object.

In an embodiment, the at least one processor may be configured to execute a second application configured to provide a function related to the selected object.

In an embodiment, the at least one processor may, in case that a plurality of second applications configured to provide a function related to the selected object are identified, display a plurality of objects corresponding to the plurality of the second applications on the display. The at least one processor may, in response to a user input for one of the plurality of the objects, by using a second application corresponding to the selected object of the plurality of second applications, perform an operation corresponding to the selected object.

In an embodiment, in case that the first application is a messaging application, the plurality of second applications may include at least one of a phone application, a media streaming application, or a calendar application.

In an embodiment, the at least one processor may be configured to, in case that the first application is a media streaming application and the operation corresponding to the selected object is an operation of playing media content corresponding to the first notification, control the electronic device or the external electronic device to play the media content using the media.

In an embodiment, a method for operating an electronic device may include obtaining information related to a first notification for a first application from an external electronic device through a communication module. The method for operating an electronic device may include displaying at least one object corresponding to at least one operation related to the first notification through a display. The method for operating an electronic device may include selecting one object from the displayed at least one object. The method for operating an electronic device may include determining, among the electronic device and the external electronic device, a device to perform an operation corresponding to the selected object, based on information including the first notification. The method for operating an electronic device may include controlling the determined device to perform the operation corresponding to the selected object.

In an embodiment, the method for operating an electronic device may further include displaying objects corresponding to the electronic device and the external electronic device through the display. The method for operating an electronic device may further include, in response to a user input for one of the displayed objects, determining, among the electronic device and the external electronic device, a device to perform the operation corresponding to the selected object. The method for operating an electronic device may further include controlling the determined device to perform the operation corresponding to the selected object.

In an embodiment, the method for operating an electronic device may further include determining, among the electronic device and the external electronic device, a device to perform the operation corresponding to the selected object, based on the state and operation pattern of the electronic device. The method for operating an electronic device may further include controlling the determined device to perform the operation corresponding to the selected object.

In an embodiment, the state of the electronic device may include the remaining battery capacity of the electronic device and a connection state with the external electronic device. The operation pattern may include a history of the electronic device performing the operation corresponding to the selected object.

In an embodiment, the method for operating an electronic device may further include, in case that the first application is stored in the electronic device, obtaining the first notification for the first application by using the first application.

In an embodiment, the method may further include determining whether the electronic device is able to perform the operation corresponding to the selected object. The method for operating an electronic device may further include, in case that the electronic device is unable to perform the operation corresponding to the selected object, requesting the external electronic device to perform the operation corresponding to the selected object.

In an embodiment, the method for operating an electronic device may further include executing a second application configured to provide a feature related to the selected object.

In an embodiment, a method for operating an electronic device may further include, in case that a plurality of second applications configured to provide a feature related to the selected object are identified, displaying a plurality of objects corresponding to the plurality of second applications through the display. The method for operating an electronic device may further include, in response to a user input for one of the plurality of objects, by using a second application corresponding to the selected object of the plurality of second applications, performing the operation corresponding to the selected object.

In an embodiment, in case that the first application is a messaging application, the plurality of second applications may include at least one of a phone application, a media streaming application, or a calendar application.

In an embodiment, the method for operating an electronic device may further include, in case that the first application is a media streaming application and the operation corresponding to the selected object is an operation of playing media content corresponding to the first notification, control the electronic device or the external electronic device to play the media content using the media.

In an embodiment, in a non-transitory storage medium storing instructions, the instructions may be configured to, when executed by at least one circuit of an electronic device, cause the at least one circuit to perform at least one operation. The at least one operation may include obtaining information related to a first notification for a first application from an external electronic device through a communication module. The at least one operation may include displaying at least one object corresponding to the at least one operation related to the first notification through a display. The at least one operation may include selecting one object from the displayed at least one object. The at least one operation may include determining, among the electronic device and the external electronic device, a device to perform the operation corresponding to the selected object, based on information including the first notification. The at least one operation may include controlling the determined device to perform the operation corresponding to the selected object.

Additionally, the data structure used in the embodiments of the disclosure described above may be recorded on a computer-readable recording medium through various measures. The computer-readable recording media may include storage media such as magnetic storage media (e.g., read only memory (ROM), floppy disk, hard disk, etc.) and optical read media (e.g., CD-ROM, digital versatile disc (DVD), etc.).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the from the spirit and scope of the disclosure as defined by the appended claims and their equivalents.

What is claimed is:

1. An electronic device comprising:
a communication module;
a display;
memory storing one or more computer programs; and
one or more processors communicatively coupled to the communication module, the display, and the memory,
wherein the one or more computer programs include computer-executable instructions that, when executed by the one or more processors individually or collectively, cause the electronic device to:
obtain, from an external electronic device, through the communication module, information related to a first notification for a first application,
display, through the display, at least one object corresponding to at least one operation related to the first notification,
select an object of the displayed at least one object;
based on information including the first notification, determine, among the electronic device and the external electronic device, a device that is to perform an operation corresponding to the selected object, and
control the determined device to perform the operation corresponding to the selected object.

2. The electronic device of claim 1, wherein the one or more computer programs further include computer-executable instructions that, when executed by the one or more processors individually or collectively, cause the electronic device to:
display, through the display, objects corresponding to the electronic device and the external electronic device;
in response to a user input for one of the displayed objects, determine, among the electronic device and the external electronic device, a device that is to perform the operation corresponding to the selected object; and
control the determined device to perform the operation corresponding to the selected object.

3. The electronic device of claim 1, wherein the one or more computer programs further include computer-executable instructions that, when executed by the one or more processors individually or collectively, cause the electronic device to:
based on a state and an operation pattern of the electronic device, determine, among the electronic device and the external electronic device, a device that is to perform the operation corresponding to the selected object; and
control the determined device to perform the operation corresponding to the selected object.

4. The electronic device of claim 3,
wherein the state of the electronic device comprises a remaining battery capacity of the electronic device and a connection state with the external electronic device, and
wherein the operation pattern comprises a history of the operation corresponding to the selected object performed by the electronic device.

5. The electronic device of claim 4, wherein the one or more computer programs further include computer-executable instructions that, when executed by the one or more processors individually or collectively, cause the electronic device to, in case that the first application is stored in the electronic device, obtain, by using the first application, the first notification for the first application.

6. The electronic device of claim 1, wherein the one or more computer programs further include computer-executable instructions that, when executed by the one or more processors individually or collectively, cause the electronic device to:
determine whether the electronic device is capable of performing the operation corresponding to the selected object; and
in case that the electronic device is incapable of performing the operation corresponding to the selected object, request the external electronic device to perform the operation corresponding to the selected object.

7. The electronic device of claim 1, wherein the one or more computer programs further include computer-executable instructions that, when executed by the one or more processors individually or collectively, cause the electronic device to execute a second application configured to provide a feature related to the selected object.

8. The electronic device of claim 7, wherein the one or more computer programs further include computer-executable instructions that, when executed by the one or more processors individually or collectively, cause the electronic device to:
in case that a plurality of second applications configured to provide a feature related to the selected object are identified, display, through the display, a plurality of objects corresponding to the plurality of second applications; and
in response to a user input for one of the plurality of objects, perform, by using a second application corresponding to the selected object of the plurality of second applications, the operation corresponding to the selected object.

9. The electronic device of claim 8, wherein, in case that the first application is a messaging application, the plurality of second applications comprise at least one of a phone application, a media streaming application, or a calendar application.

10. The electronic device of claim 1, wherein the one or more computer programs further include computer-executable instructions that, when executed by the one or more processors individually or collectively, cause the electronic device to, in case that the first application is a media streaming application and the operation corresponding to the selected object is an operation of playing media content corresponding to the first notification, control the electronic device or the external electronic device (102; 900) to play the media content.

11. A method for performing an operation related to a notification by an electronic device, the method comprising:
obtaining, from an external electronic device, through a communication module, information related to a first notification for a first application;
displaying, through a display, at least one object corresponding to at least one operation related to the first notification;
selecting an object of the displayed at least one object;
based on information including the first notification, determining, among the electronic device and the external electronic device, a device that is to perform an operation corresponding to the selected object; and
controlling the determined device to perform the operation corresponding to the selected object.

12. The method of claim 11, further comprising:
displaying, through the display, objects corresponding to the electronic device and the external electronic device;
in response to a user input for one of the displayed objects, determining, among the electronic device and the external electronic device, a device that is to perform the operation corresponding to the selected object; and
controlling the determined device to perform the operation corresponding to the selected object.

13. The method of claim 11, further comprising:
based on a state and an operation pattern of the electronic device, determining, among the electronic device and the external electronic device, a device that is to perform the operation corresponding to the selected object; and
controlling the determined device to perform the operation corresponding to the selected object.

14. The method of claim 13,
wherein the state of the electronic device comprises a remaining battery capacity of the electronic device and a connection state with the external electronic device, and
wherein the operation pattern comprises a history of the operation corresponding to the selected object performed by the electronic device.

15. The method of claim 11, further comprising, in case that the first application is stored in the electronic device, obtaining, by using the first application, the first notification for the first application.

16. The method of claim 11, further comprising:
determining whether the electronic device is capable of performing the operation corresponding to the selected object; and
in case that the electronic device is incapable of performing the operation corresponding to the selected object, requesting the external electronic device to perform the operation corresponding to the selected object.

17. The method of claim 11, further comprising executing a second application configured to provide a feature related to the selected object.

18. The method of claim 17, further comprising:
in case that a plurality of second applications configured to provide a feature related to the selected object are identified, displaying, through the display, a plurality of objects corresponding to the plurality of second applications; and
in response to a user input for one of the plurality of objects, performing, by using a second application corresponding to the selected object of the plurality of second applications, the operation corresponding to the selected object.

19. One or more non-transitory computer-readable storage media storing one or more computer programs including computer-executable instructions that, when executed by one or more processors of an electronic device individually or collectively, cause the electronic device to perform operations, the operations comprising:
obtaining, from an external electronic device, through a communication module, information related to a first notification for a first application;
displaying, through a display, at least one object corresponding to at least one operation related to the first notification;
selecting an object of the displayed at least one object;
based on information including the first notification, determining, among the electronic device and the external electronic device, a device that is to perform an operation corresponding to the selected object; and
controlling the determined device to perform the operation corresponding to the selected object.

20. The one or more non-transitory computer-readable storage media of claim 19, the operations further comprising:
displaying, through the display, objects corresponding to the electronic device and the external electronic device;
in response to a user input for one of the displayed objects, determining, among the electronic device and the external electronic device, a device that is to perform the operation corresponding to the selected object; and
controlling the determined device to perform the operation corresponding to the selected object.
